(19) United States
(12) Patent Application Publication
(10) Pub. No.: US 2021/0349737 A1
(43) Pub. Date: Nov. 11, 2021

(54) SYSTEM AND METHOD FOR LOADING AN AGENT CLASS

(71) Applicant: HCL TECHNOLOGIES LIMITED, Hertzelia (IL)

(72) Inventors: Jonathan AFEK, Kfar Saba (IL); Gal BEN-YAIR, Givaat Shmuel (IL)

(73) Assignee: HCL TECHNOLOGIES LIMITED, Hertzelia (IL)

(21) Appl. No.: 16/868,829

(22) Filed: May 7, 2020

(51) Int. Cl. G06F 9/445; G06F 16/955; G06F 9/4401

(52) U.S. Cl. CPC G06F 9/44521; G06F 9/4416; G06F 16/9566

(57) ABSTRACT

The present disclosure relates to system(s) and method(s) for loading an agent class. The method comprises creating an URL class loader by a servlet associated with an agent class. The URL class loader is configured to load an agent code associated with the agent class, and libraries associated with the agent code. The method further comprises loading a reference holder class into a bootstrap class loader. The reference holder class holds a reference of the URL class loader. Further, the method comprises loading the agent class in the web server environment based on the reference of the URL class loader directly from the bootstrap class loader.

### CROSS-REFERENCE TO RELATED APPLICATIONS AND PRIORITY

The present application does not claim priority from any patent application.

### TECHNICAL FIELD

The present disclosure in general relates to the field of loading an agent class. More particularly, the present invention relates to a system and method for loading an agent class in web server environment.

### BACKGROUND

Currently, when running a java agent in a web server environment, the main difficulty comes from dealing with specialized class loaders created by the different types of web servers. Usually, the web servers launch servlets under their own class loaders that have specialized behavior meant to prevent the servlets from accessing other servlets. In one example, the tomcat web server attempts to load classes before asking parent class loaders to do so. This is the opposite of standard java behavior whereby each class loader must first ask the parent class loader to load a class before attempting to do it on its own. Other web servers, such as WebSphere liberty uses specialized class loaders (OSGI) which prevent any loading from bootstrap of any class that does not conform to a predefined definition. This is because the agent runs under the web server class loader, any attempt to load classes from the bootstrap or system class loaders is first handled by web server which may block the attempt altogether. It is to be noted that a servlet may attempt to create its own class loader that will force the proper loading of classes. However, that leads to situations such as deadlocks because of collision caused from other class loaders.

### SUMMARY

Before the present systems and methods for loading an agent class, is described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for loading an agent class. This summary is not intended to identify essential features of the claimed subject matter nor is it intended for use in determining or limiting the scope of the claimed subject matter.

In one implementation, a method for loading an agent class in a web server environment is disclosed. The method may comprise creating, by a processor, an URL class loader by a servlet associated with an agent class. The URL class loader may be configured to load an agent code associated with the agent class, and libraries associated with the agent code. The method may further comprise loading, by the processor, a reference holder class into a bootstrap class loader. The reference holder class may hold a reference of the URL class loader. The method may further comprise loading, by the processor, the agent class in the web server environment based on the reference of the URL class loader from the bootstrap class loader.

In another implementation, a system for loading an agent class in a web server environment is disclosed. The system may comprise a memory and a processor coupled to the memory. The processor may be configured to execute instructions stored in the memory to create an URL class loader by a servlet associated with an agent class. The URL class loader may be configured to load an agent code associated with the agent class, and libraries associated with the agent code. The processor may be further configured to execute instructions stored in the memory to load a reference holder class into a bootstrap class loader. The reference holder class may hold a reference of the URL class loader. The processor may be further configured to execute instructions stored in the memory to load the agent class in the web server environment based on the reference of the URL class loader from the bootstrap class loader.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation 100 of a system 102 for loading an agent class in a web server environment, in accordance with an embodiment of the present subject matter.

FIG. 2 illustrates the system 102 for loading the agent class in the web server environment, in accordance with an embodiment of the present subject matter.

FIG. 3 illustrates a method 300 for loading an agent class in a web server environment, in accordance with an embodiment of the present subject matter.

### DETAILED DESCRIPTION

Some embodiments of the present disclosure, illustrating all its features, will now be discussed in detail. The words “including”, “comprising”, “consisting”, “containing”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods for loading an agent class are now described. The disclosed embodiments of the system and method for loading the agent class are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for loading an agent class is not intended to be limited to the embodiments illustrated, but is to be accorded the widest scope consistent with the principles and features described herein.

In one embodiment, a method for loading an agent class in a web server environment is disclosed. In the embodiment, an URL class loader may be created by a servlet associated with an agent class. Further, a reference holder class may be loaded into a bootstrap class loader. The reference holder class may hold a reference of the URL class loader. Furthermore, the agent class may be loaded in the web server environment based on the reference of the URL class loader from the bootstrap class loader.

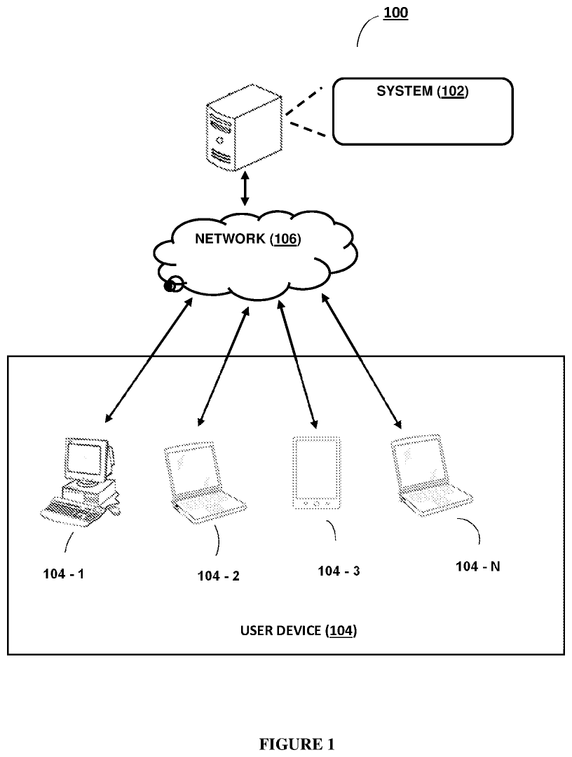

Referring now to FIG. 1, a network implementation 100 of a system 102 for loading an agent class in a web server environment is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

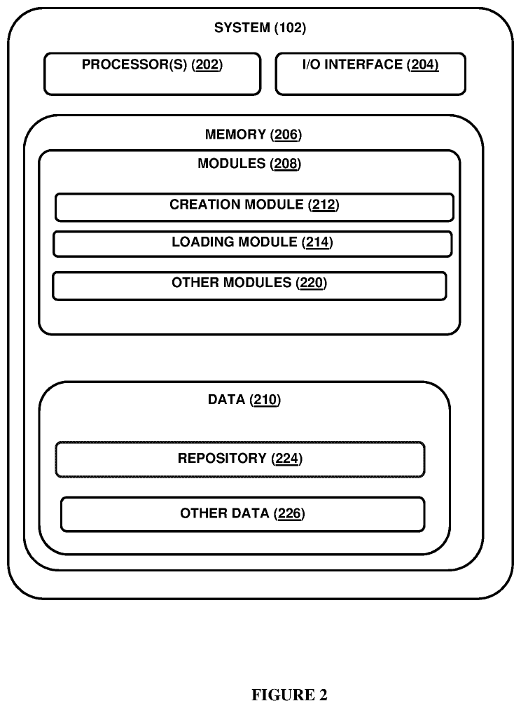

Referring now to FIG. 2, the system 102 for loading an agent class in a web server environment is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a creation module 212, a loading module 214, and other modules 220. The other modules 220 may include programs or coded instructions that supplement applications and functions of the system 102.

The data 210, amongst other things, serve as a repository for storing data processed, received, and generated by one or more of the modules 208. The data 210 may also include a repository 224, and other data 226. In one embodiment, the other data 226 may include data generated as a result of the execution of one or more modules in the other modules 220.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the creation module 212 may be configured to create an URL class loader by a servlet associated with an agent class. The URL class loader may load an agent code associated with the agent class, and one or more libraries associated with the agent code.

In one aspect, a .war file associated with the servlet may be changed, post build, in order to remove the required libraries from within the .war file and put the required libraries inside an agent library which is a .jar file. When the .war file is deployed, the agent .jar file may be deployed. Further, the required libraries may be kept in a predefined folder where a web server will not access the required libraries. The required libraries may be referred as predefined libraries.

Further, the servlet may extract the predefined libraries from the predefined folder, as described in the previous section. Further, the predefined libraries may be used by the servlet to create the URL class loader. The URL class loader may use agent files and the predefined libraries as it's search path. Using this method, there may be only one class loader aware of the agent and its libraries and that can run the agent under the servlet.

Further, the loading module 214 may load a reference class holder in a bootstrap class loader. The reference class holder may hold a single reference to the URL class loader. In one aspect, the bootstrap class loader may act as a parent for the URL class loader.

Furthermore, the loading module 214 may be configured to load the agent class in a web server environment. In one embodiment, the loading module 214 may be configured to access the URL class loader directly from the bootstrap class loader. Based on this, the loading module 214 may be configured to allow an access to the agent code from the bootstrap class loader. In one aspect, based on the reference in the bootstrap class loader, the agent code may be called from any threat, context, and class loader. Further, based on the access, the agent class may be loaded in the web server environment.

In one embodiment, based on storing the reference in the bootstrap class loader, any thread and any class loader may load agent classes by accessing the reference directly from bootstrap.

Further, the loading module 214 may be configured to instrument a JVM class loading mechanism to override, update or inject the agent code in the class loader. Furthermore, the loading module 214 may be configured to transform one or more methods associated with the agent class using an open source library, thereby allowing the agent class to perform actions defined in the servlet, and overriding other class loader behavior based on requirements.

In one embodiment, when a loadClass method is called, the loading module 214 may be configured to check whether the class loaded is an agent class. If so, the loading module 214 may override the original class loaders' code and force the loading of the agent class, thereby bypassing any filter or limitation imposed by a web server class loader.

Exemplary embodiments discussed above may provide certain advantages. Though not required to practice aspects of the disclosure, these advantages may include those provided by the following features.

Some embodiments of the system and the method enables the agent to hook specific code. This means that when hooked code is called, the agent code is called first.

Some embodiments of the system and the method enables the agent to change the class loader by looking at the bootstrap reference holder class and getting the class loader stored there.

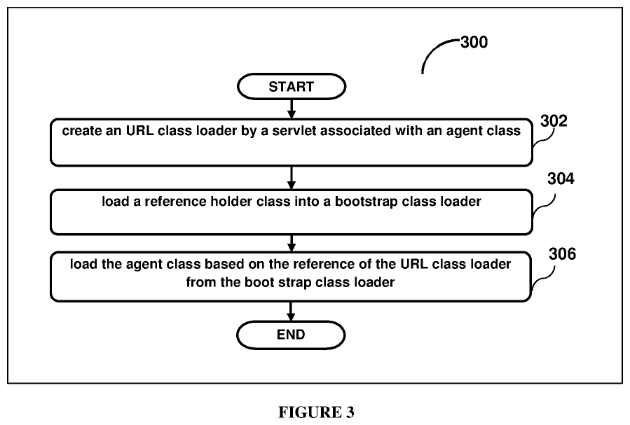

Referring now to FIG. 3, a method 300 for loading an agent class in a web server environment, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, an URL class loader may be created by a servlet. In one implementation, the creation module 212 may create the URL class loader. The URL class loader may be configured to load an agent code associated with the agent class, and libraries associated with the agent code.

At block 304, a reference holder class may be loaded into a bootstrap class loader. In one implementation, the loading module 214 may load the reference holder class into the bootstrap class loader. The reference holder class may be configured to hold a reference of the URL class loader.

At block 306, the agent class may be loaded in the web server environment based on the reference of the URL class loader from the bootstrap class loader. In one implementation, the loading module 214 may load the agent class based on the reference of the URL class loader directly from the bootstrap class loader.

Although implementations for systems and methods for loading an agent class have been described, it is to be understood that the appended claims are not necessarily limited to the specific features or methods described. Rather, the specific features and methods are disclosed as examples of implementations for loading the agent class.

1. A method for loading an agent class in a web server environment, the method comprises:
creating, by a processor, an URL class loader by a servlet associated with an agent class, wherein the URL class loader is configured to load an agent code associated with the agent class, and libraries associated with the agent code;
loading, by the processor, a reference holder class into a bootstrap class loader, wherein the reference holder class holds a reference of the URL class loader; and
loading, by the processor, the agent class in the web server environment based on the reference of the URL class loader from the bootstrap class loader.

2. The method as claimed in claim 1, further comprises instrumenting a JVM class loading mechanism to override, update or inject the agent code in the class loader.

3. The method as claimed in claim 1, further comprises transforming one or more methods associated with the agent class using an open source library, thereby allowing the agent class to perform actions defined in the servlet, and overriding other class loader behavior based on requirements.

4. The method as claimed in claim 1, wherein the URL class loader is created based on predefined libraries extracted by the servlet from a predefined folder.

5. The method as claimed in claim 1, wherein the URL class loader is configured to use the predefined libraries as a search path.

6. A system for loading an agent class in a web server environment, the system comprises:
a memory;
a processor coupled to the memory, wherein the processor is configured to execute instructions stored in the memory to:
create an URL class loader by a servlet associated with an agent class, wherein the URL class loader is configured to load an agent code associated with the agent class, and libraries associated with the agent code;
load a reference holder class into a bootstrap class loader, wherein the reference holder class holds a reference of the URL class loader; and
load the agent class in the web server environment based on the reference of the URL class loader from the bootstrap class loader.

7. The system as claimed in claim 6, further configured to instrument a JVM class loading mechanism to override, update or inject the agent code in the class loader.

8. The system as claimed in claim 6, further configured to transform one or more methods associated with the agent class using an open source library, thereby allowing the agent class to perform actions defined in the servlet, and overriding other class loader behavior based on requirements.

9. The system as claimed in claim 6, wherein the URL class loader is created based on predefined libraries extracted by the servlet from a predefined folder.

10. The system as claimed in claim 6, wherein the URL class loader is configured to use the predefined libraries as a search path.
